(19) United States
(12) Patent Application Publication
(10) Pub. No.: US 2019/0386540 A1
(43) Pub. Date: Dec. 19, 2019

(54) ALTERNATOR APPARATUS AND VOLTAGE CONVERTER THEREOF

(71) Applicant: ACTRON TECHNOLOGY CORPORATION, Taoyuan City (TW)

(72) Inventors: Chia-Sung Yu, Taoyuan City (TW); Ching-Jan Chen, Taoyuan City (TW); Yuan-Chih Lin, Taoyuan City (TW)

(73) Assignee: ACTRON TECHNOLOGY CORPORATION, Taoyuan City (TW)

(21) Appl. No.: 16/132,484

(22) Filed: Sep. 17, 2018

(30) Foreign Application Priority Data
Jun. 13, 2018 (TW) 107120338

(51) Int. Cl. H02K 7/02; H02M 3/156; H02P 9/14; B60L 11/16

(52) U.S. Cl. CPC H02K 7/025; H02M 3/156; B60L 2210/14; B60L 11/16; B60L 2210/12; H02P 9/14

(57) ABSTRACT

An alternator apparatus and a voltage converter thereof are provided. The voltage converter includes a voltage converting circuit and an auxiliary circuit. The voltage converting circuit has a first power end, a second power end and an inductor. The voltage converting circuit converts a first voltage on the first power end to generate a second voltage on the second power end during an operation time period, or the voltage converting circuit converts the second voltage on the second power end to generate the first voltage on the first power end during the operation time period. The auxiliary circuit forms a first loop between the first power end and the inductor during a reset time period, or forms a second loop between the second power end and the inductor during the reset time period, or forms a third loop in the auxiliary circuit.

### CROSS-REFERENCE TO RELATED APPLICATION

This application claims the priority benefit of Taiwan application serial no. 107120338, filed on Jun. 13, 2018. The entirety of the above-mentioned patent application is hereby incorporated by reference herein and made a part of this specification.

### BACKGROUND OF THE INVENTION

### Field of the Invention

The invention relates to an alternator apparatus and a voltage converter, particularly related to an alternator apparatus and a voltage converter which can execute electric energy recovery and energy flywheel.

### Description of Related Art

In vehicle devices, power generators for vehicles are usually composed of rotors, stators, bridge rectifiers, regulators, and pulleys. According to the working principle of a power generator, an excitation is executed in the rotor, such that the rotor generates a magnetic field, and rotates according to energy provided by an engine. Through the rotation of the rotor, the magnetic field of the rotor cuts a stator coil. In addition, by cutting effect of the magnetic field, the stator generates AC power correspondingly, and the generated AC power is rectified to DC power after a full wave rectification. The generated power is transferred to a battery and an electrical load of a vehicle.

To correspond to the present electronic applications of vehicles, alternator apparatus of vehicle devices may generate a plurality of powers (e.g. dual power) by using voltage converters. Furthermore, when load dumping of the alternator apparatus occurs, the alternator apparatus generates unstable bounce owing to rapid changes of load state. Improving the efficiency of power usage of the alternator apparatus, and reducing the impact caused by load dumping are important issues for people skilled in the art.

### SUMMARY OF THE INVENTION

The invention provides an alternator apparatus and a voltage converter, which can execute an electric energy recovery during a reset time period.

The voltage converter of one exemplary embodiment of the invention includes a voltage converting circuit and an auxiliary circuit. The voltage converting circuit comprises a first power end, a second power end and an inductor. The voltage converting circuit, during an operation time period, converts a first voltage on the first power end so as to generate a second voltage on the second power end, or the voltage converting circuit, during the operation time period, converts the second voltage on the second power end so as to generate the first voltage on the first power end, wherein a voltage value of the first voltage is larger than a voltage value of the second voltage. The auxiliary circuit is coupled between the first power end and the second power end. The auxiliary circuit, during the reset time period, forms a first loop between the first power end and the inductor, or forms a second loop between the second power end and the inductor, or forms a third loop in the auxiliary circuit. The first loop and the second loop execute electric energy recovery, and the third loop executes energy flywheel.

The alternator apparatus of one exemplary embodiment of the invention includes a power generator and the aforementioned voltage converter. The power generator has a rotor and a stator, where the stator generates an output voltage. The power generator transmits the output voltage to the first power end or the second power end of the voltage converter as the first power or the second power.

In view of the above, the voltage converter of one exemplary embodiment of the invention, during the operation time period, provides different modes of voltage converting operation. In addition, during the reset time period, a circuit loop is formed between a reference ground end and the first power end or the second power end to execute energy recovery or energy flywheel. As such, when the load dumping of the alternator apparatus occurs, the value of the output voltage will become stable rapidly, and the probability of having negative effects on the system will be reduced.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 illustrates a schematic view of a voltage converter of an embodiment of the invention.

FIG. 2A illustrates a schematic view of a voltage converter of an embodiment of the invention.

FIG. 2B illustrates a schematic view of an operation method of a voltage converter of an embodiment of the invention.

FIG. 3 illustrates a schematic view of a voltage converter of another embodiment of the invention.

FIG. 4 illustrates a schematic view of a voltage converter of still another embodiment of the invention.

FIG. 5A to FIG. 5D respectively illustrate equivalent circuit diagrams of a plurality of operation methods of a voltage converter.

FIG. 6 illustrates a schematic view of a voltage converter of an embodiment of the invention.

FIG. 7A to FIG. 7B illustrate schematic views of an alternator apparatus of embodiments of the invention.

### DESCRIPTION OF THE EMBODIMENTS

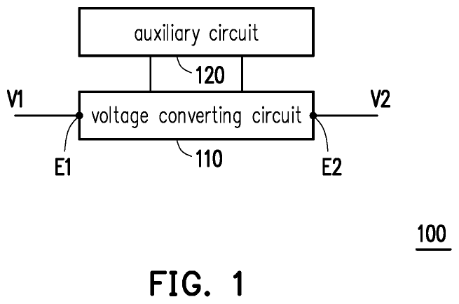

FIG. 1 illustrates a schematic view of a voltage converter of an embodiment of the invention. A voltage converter 100 includes a voltage converting circuit 110 and an auxiliary circuit 120. The voltage converting circuit 110 has a first power end E1 and a second power end E2. The auxiliary circuit 120 is coupled to the voltage converting circuit 110. The voltage converting circuit 110 has dual operating modes, one of which is in a boost mode, and the other of which is in a buck mode. When the voltage converting circuit 110 operates during an operation time period in the boost mode, the second power end E2 of the voltage converting circuit 110 is an input end, and the voltage converting circuit 110 receives a voltage V2 by the second power end E2. A voltage converting operation in the boost mode is executed according to the voltage V2, so as to generate a voltage V1 on the first power end E1, where a voltage value of the voltage V1 is larger than a voltage value of the voltage V2.

On the other hand, when a load dumping occurs, the voltage converting circuit 110 operates during a reset time period in the boost mode. At this time, the voltage converting circuit 110 stops executing the voltage converting operation. Correspondingly, a loop is formed through the auxiliary circuit 120, which is between the second power end E2 as the input end and a reference ground, and thus during the reset time period, the energy stored on the voltage converting circuit 110 could be recovered to the input end (i.e. the second power end E2) or be stored by executing flywheel energy storage for extra energy, so as to rapidly reduce voltage fluctuation situation of the voltage V1 and the voltage V2. The flywheel energy storage mentioned in the embodiment is by continuing the energy flow in a current loop. As such, the electric energy may be effectively stored in a current loop, and may not be wasted. Moreover, when the voltage converter 100 restarts to operate, a normal operating state may be rapidly resumed.

Besides, when the voltage converting circuit 110 operates during the operation time period in the buck mode, the first power end E1 of the voltage converting circuit 110 is used as an input end. The voltage converting circuit 110 receives the voltage V1 by the first power end E1, and the voltage converting operation in the buck mode is executed according to the voltage V1, so as to generate the voltage V2 on the second power end E2.

On the other hand, when, for example, the load dumping occurs, the voltage converting circuit 110 operates during the reset time period in the buck mode. At this time, the voltage converting circuit 110 stops executing the voltage converting operation. Correspondingly, a loop is formed through the auxiliary circuit 120, which is between the first power end E1 (used as the input end) and the reference ground end, and thus during the reset time period, the energy stored on the voltage converting circuit 110 could be recovered to the input end (the first power end E1), or flywheel energy storage could be executed in the auxiliary circuit 120, so as to rapidly reduce voltage fluctuation situation of the voltage V1 and the voltage V2.

Based on the aforementioned illustrations, it is acquired that, when the voltage (the voltage V1 or V2) state occurs abnormal changes (for example, having the load dumping), by the loop formed through the auxiliary circuit 120 during the reset time period, the energy stored in the voltage converting circuit 110 may be effectively recovered to the input end or be stored by executing the flywheel energy storage in the auxiliary circuit 120. The voltage instability caused by the load dumping may be rapidly reduced. Apart from effectively applying energy, the voltage generated by the voltage converting circuit 110 may become stable rapidly, so as to enhance the stability of the system operation.

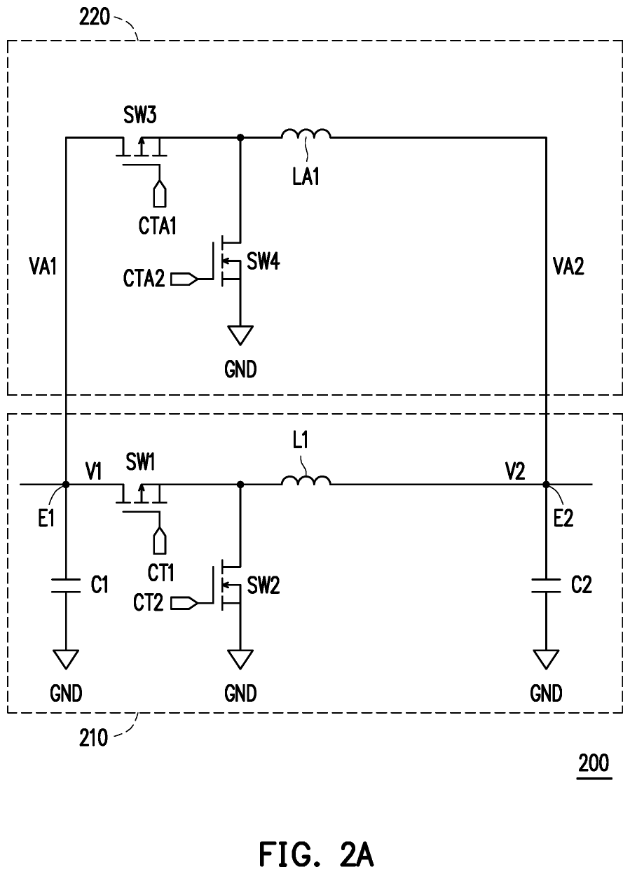

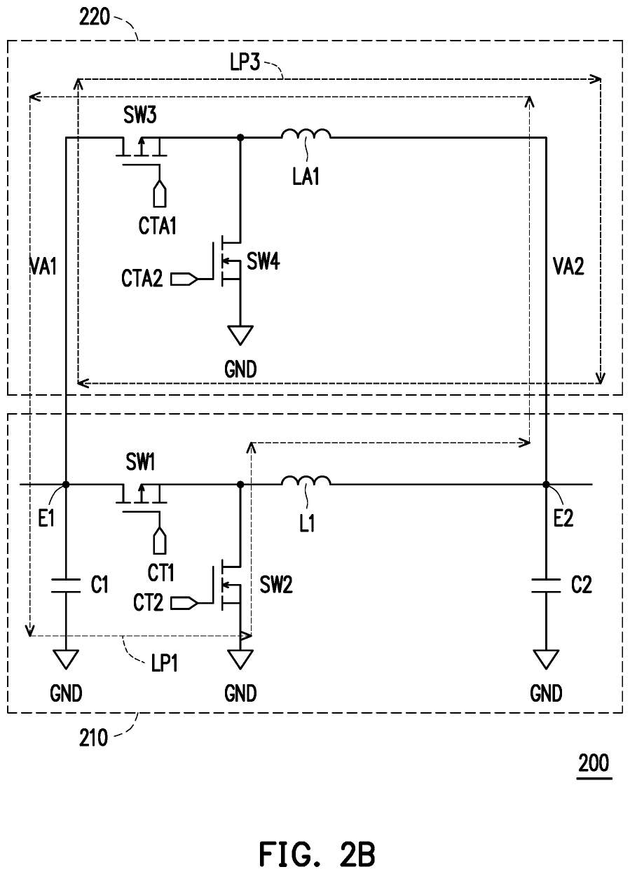

FIG. 2A illustrates a schematic view of a voltage converter of an embodiment of the invention. A voltage converter 200 includes a voltage converting circuit 210 and an auxiliary circuit 220.

The voltage converting circuit 210 has the first power end E1 and the second power end E2. The voltage converting circuit 210 includes switches SW1 and SW2 and an inductor L1. The switches SW1 and SW2 are constructed by transistors. Regarding an operation method of the voltage converting circuit 210, during the operation time period in the boost mode, the switches SW1 and SW2 are interactively turned on and turned off, and a boost operation is executed according to the voltage V2. When the switch SW2 is turned on (while the switch SW1 is turned off), a loop is formed through the second power end E2, the inductor L1 and the switch SW2, such that the inductor L1 stores energy. Then, when the switch SW1 is turned on (while the switch SW2 is turned off), the energy in the inductor L1 is provided to the first power end E1 through the switch SW1, and the voltage V1 is generated.

During the operation time period in the buck mode, the switches SW1 and SW2 are interactively turned on and turned off, a buck operation is executed according to the voltage V1, and the voltage V2 is generated on the second power end E2. When the switch SW1 is turned on (while the switch SW2 is turned off), a loop is formed through the first power end E1, the switch SW1, and the inductor L1, such that the inductor L1 stores energy according to the voltage V1. Then, when the switch SW2 is turned on (while the switch SW1 is turned off), a first end of the inductor L1 is coupled to a reference ground end GND through the switch SW2, and the buck operation is executed to generate the voltage V2.

In this embodiment, the auxiliary circuit 220 includes switches SW3 and SW4 and an auxiliary inductor LA1. The switch SW3 is coupled between the first power end E1 and a first end of the auxiliary inductor LA1, and is controlled by a control signal CTA1, so as to be turned on or turned off. The switch SW4 is serially connected between the first end of the auxiliary inductor LA1 and the reference ground end GND, and is controlled by a control signal CTA2 so as to be turned on or turned off. A second end of the auxiliary inductor LA1 is coupled to the second power end E2.

During the operation time period, the operation manners of the auxiliary circuit 220 and the voltage converting circuit 210 are similar. For example, when the voltage converting circuit 210 executes a voltage converting operation of buck and generates the voltage V2, the auxiliary circuit 220 provides transient energy flow, so as to generate an auxiliary voltage VA2 on the second power end E2 according to the voltage V1. Similarly, when the voltage converting circuit 210 executes a voltage converting operation of boost and generates the voltage V1, the auxiliary circuit 220 also provides transient energy flow, so as to generate the auxiliary voltage VA1 on the first power end E1 according to the voltage V2. It should be noted that, an operating bandwidth of the auxiliary circuit 220 is larger than an operating bandwidth of the voltage converting circuit 210.

Specifically, when the voltage converting circuit 210 and the auxiliary circuit 220 executes a voltage converting operation of buck at the same time, a switching frequency of the switch SW3 is higher than a switching frequency of the switch SW1, such that the operating bandwidth of the auxiliary circuit 220 is larger than the operating bandwidth of the voltage converting circuit 210. On the other hand, when the voltage converting circuit 210 and the auxiliary circuit 220 execute the voltage converting operation of boost at the same time, a switching frequency of the switch SW3 and a switching frequency of the switch SW4 are higher than the switching frequencies of the switches SW1 and SW2, such that the operating bandwidth of the auxiliary circuit 220 is larger than the operating bandwidth of the voltage converting circuit 210.

On the other hand, please refer to FIG. 2B illustrating a schematic view of an operation method of a voltage converter of an embodiment of the invention during the reset time period. During the reset time period in the buck mode, the switch SW2 in the voltage converting circuit 210 and the switch SW3 in the auxiliary circuit 220 are constantly in a turn-on state, which are constantly turned on, whereas the switch SW1 in the voltage converting circuit 210 and the switch SW4 in the auxiliary circuit 220 are constantly in a turn-off state, which are constantly turned off. As such, a loop LP1 is formed through the first power end E1, the switch SW3, the auxiliary inductor LA1, the inductor L1, the switch SW2 and the reference ground end GND. Through the loop LP1, during the reset time period in the buck mode, the energy stored in the inductor L1 and the auxiliary inductor LA1 may be recycled to the first power end E1.

On the other hand, during the reset time period in the boost mode, the switch SW1 in the voltage converting circuit 210 and the switch SW3 in the auxiliary circuit 220 are constantly in the turn-on state, whereas the switch SW2 in the voltage converting circuit 210 and the switch SW4 in the auxiliary circuit 220 are constantly in the turn-off state. As such, a loop LP3 is formed in the auxiliary circuit 220. Through the loop LP3, during the reset time period in the boost mode, the energy flywheel operation is executed in the auxiliary circuit 220.

It should be noted that, in the voltage converter 200 of the embodiment, during the operation time period, the auxiliary voltage VA1 or VA2 is provided by the auxiliary circuit 210 to effectively enhance efficiency. In addition, during the reset time period, by providing energy recovering or by energy flywheel, extent of voltage overshoot or undershoot of the generated voltage V1 or V2 may be effectively reduced to maintain the system stability.

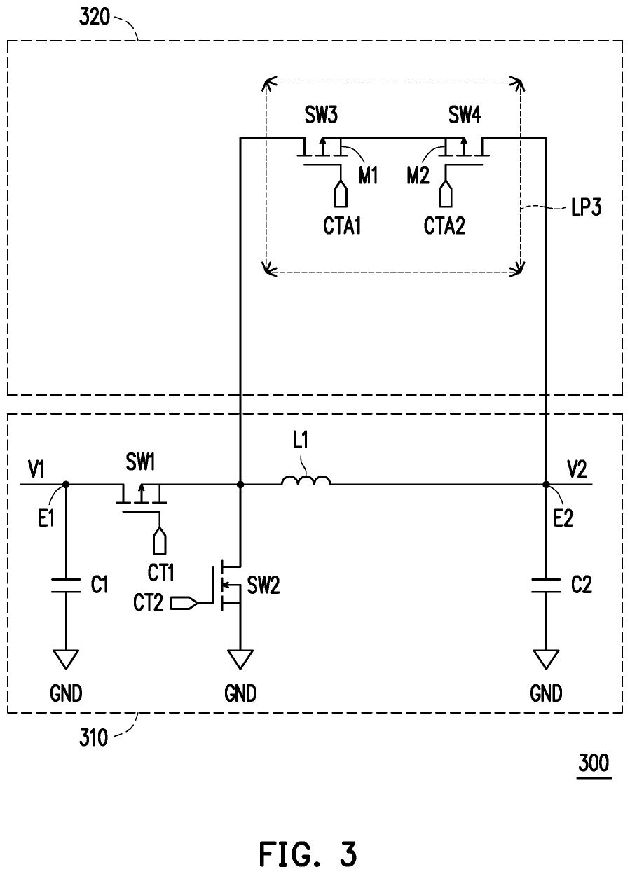

FIG. 3 illustrates a schematic view of a voltage converter of another embodiment of the invention. A voltage converter 300 includes a voltage converting circuit 310 and an auxiliary circuit 320. A circuit architecture of the voltage converting circuit 310 is similar to that of the aforementioned voltage converting circuit 210, and shall not be repeated. The auxiliary circuit 320 includes the switches SW3 and SW4, where the switches SW3 and SW4 are serially connected between the first end of the inductor L1 and the second power end E2, and are controlled by to be turned on or turned off respectively by the control signals CTA1 and CTA2. It should be noted that, transistors M1 and M2, respectively used to construct switches SW3 and SW4, have bulks coupled to each other, and coupled between the switch SW1 and the second power end E2 in a back-to-back manner, where a first end of the transistor M1 is coupled to the first end of the inductor L1, and the bulk end of the transistor M1 is coupled with a second end of the transistor M1 which is coupled to the first end of the transistor M2. Furthermore, a bulk end of the transistor M2 is coupled to the first end of the transistor M2, while the second end of the transistor M2 is coupled to the second power end E2. The control ends of the transistors M1 and M2 respectively receive the control signals CTA1 and CTA2.

While entering the reset time period, the switches SW3 and SW4 are turned on. The loop LP3 is formed through the switches SW3 and SW4 and the inductor L1 to execute energy flywheel operation, where an energy transmission direction of the loop LP3 is related to whether the voltage converter 300 operates in the boost mode or in the buck mode. When the voltage converter 300 operates in the buck mode, the energy transmission direction of the loop LP3 is in counterclockwise direction. Contrarily, when the voltage converter 300 operates in the boost mode, the energy transmission direction of the loop LP3 is in clockwise direction.

In this embodiment, the transistors M1 and M2 are coupled in the back-to-back manner. Resistance value provided when the transistors M1 and M2 are turned on is lowered, so as to improve the performance of energy flywheel.

With the aforementioned energy recovery or energy flywheel mechanism, when the voltage V1 or V2 generated by the voltage converter 300 occurs abnormal changes, such as overshoot or undershoot, the voltage variation may be reduced thereby, and a steady state may be quickly returned.

It should be noted that, in the voltage converter 300 of the embodiment, through energy flywheel operation during the reset time period, the extent of voltage overshoot of the generated voltage V1 or V2 may be effectively reduced. In addition, it is not necessary for the loop LP3 generated by the voltage converter 300 to operate with a battery element as an auxiliary mechanism for energy recovery, and the variation degree of the voltage V1 or V2 is effectively stable. Besides, the auxiliary circuit 320 of this embodiment merely requires simple circuit architecture. Therefore, the design also has its advantages on design cost.

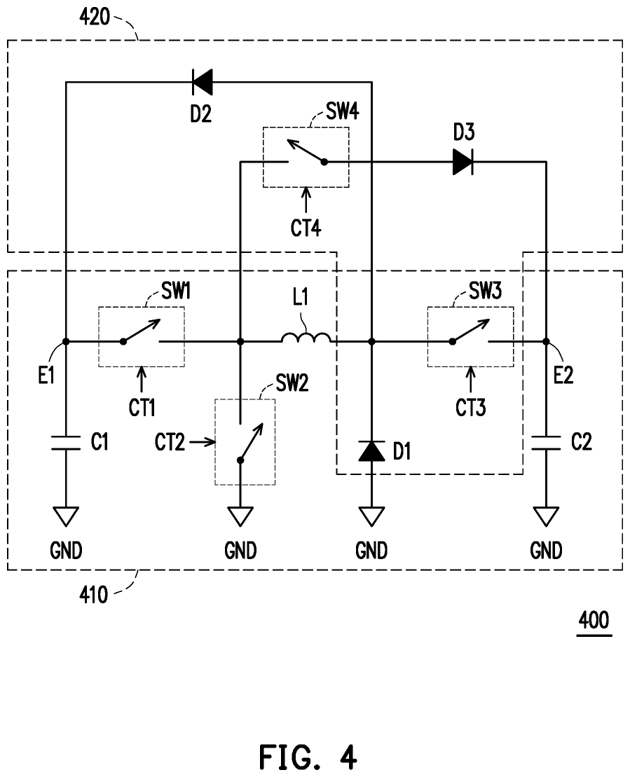

FIG. 4 illustrates a schematic view of a voltage converter of still another embodiment of the invention. A voltage converter 400 includes a voltage converting circuit 410 and an auxiliary circuit 420. The voltage converting circuit 410 includes an inductor L1, switches SW1-SW3 and a diode D1. The switch SW1 is coupled between a first end of the inductor L1 and a first power end E1. The switch SW1 receives a control signal CT1, so as to be turned on or turned off according to the control signal CT1. The switch SW2 is coupled between the first end of the inductor L1 and a reference ground end GND to receive a control signal CT2, and to be turned on or turned off according to the control signal CT2. The diode D1 is coupled between a second end of the inductor L1 and the reference ground end GND, where an anode of the diode D1 is coupled to the reference ground end GND, and a cathode of the diode D1 is coupled to the second end of the inductor L1. Besides, the switch SW3 is coupled between the second end of the inductor L1 and a second power end E2. The switch SW3 also receives a control signal CT3, so as to be turned on or turned off according to the control signal CT3.

In this embodiment, a capacitor C1 is coupled between the first power end E1 and the reference ground end GND, and a capacitor C2 is coupled between the second power end E2 and the reference ground end GND, where the capacitors C1 and C2 may be used as voltage regulating (energy storing) capacitors.

On the other hand, the auxiliary circuit 420 includes switches SW3 and SW4, and diodes D1, D2 and D3. The auxiliary circuit 420 and the voltage converting circuit 410 share some elements such as the diode D1 and the switch SW3. The diode D1 is coupled between the second end of the inductor L1 and the reference ground end GND, where the anode of the diode D1 is coupled to the reference ground end GND, and the cathode of the diode D1 is coupled to the second end of the inductor L1. Besides, the switch SW3 is coupled between the second end of the inductor L1 and the second power end E2. The switch SW3 also receives the control signal CT3, so as to be turned on or turned off according to the control signal CT3. The diode D2 is coupled between the first power end E1 and the second end of the inductor L1. The diode D3 is coupled between the second power end E2 and the switch SW4. The switch SW4 is further coupled to the first end of the inductor L1, receiving and being controlled by a control signal CT4 so as to be turned on or turned off, where the anode of the diode D2 is coupled to the second end of the inductor L1, and the cathode of the diode D2 is coupled between the first power end E1. The anode of the diode D3 is coupled to the first end of the inductor L1. The cathode of the diode D3 is coupled to the second power end E2.

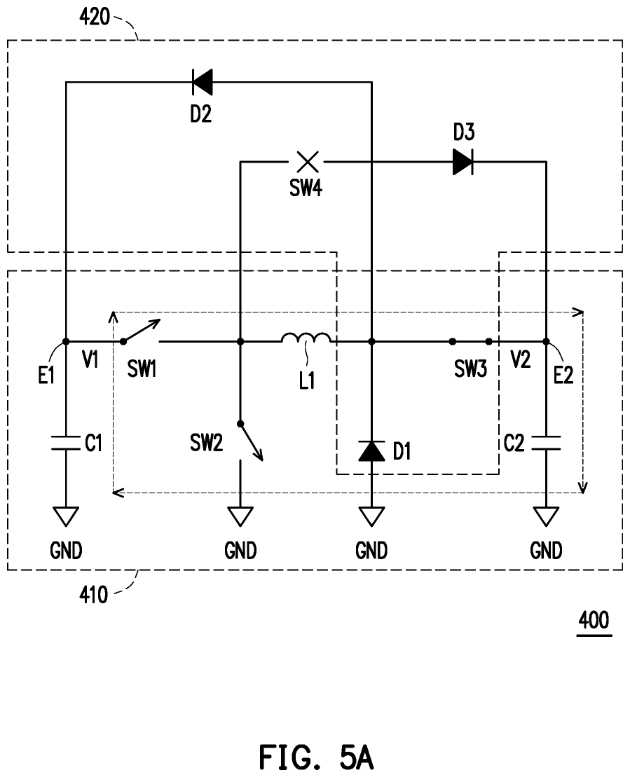

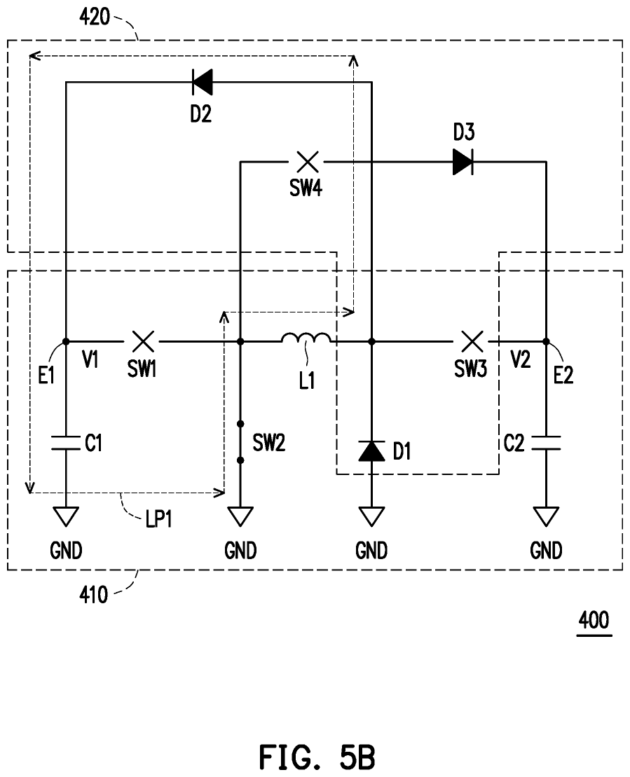

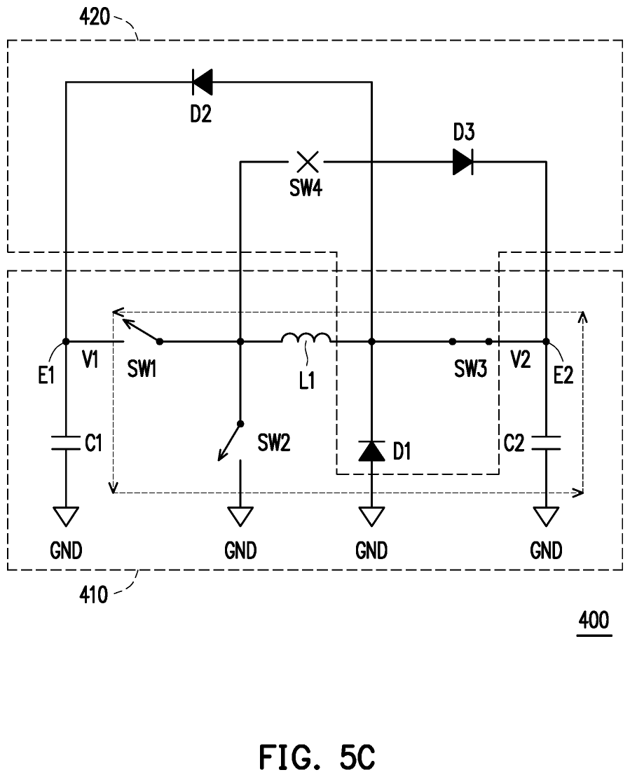

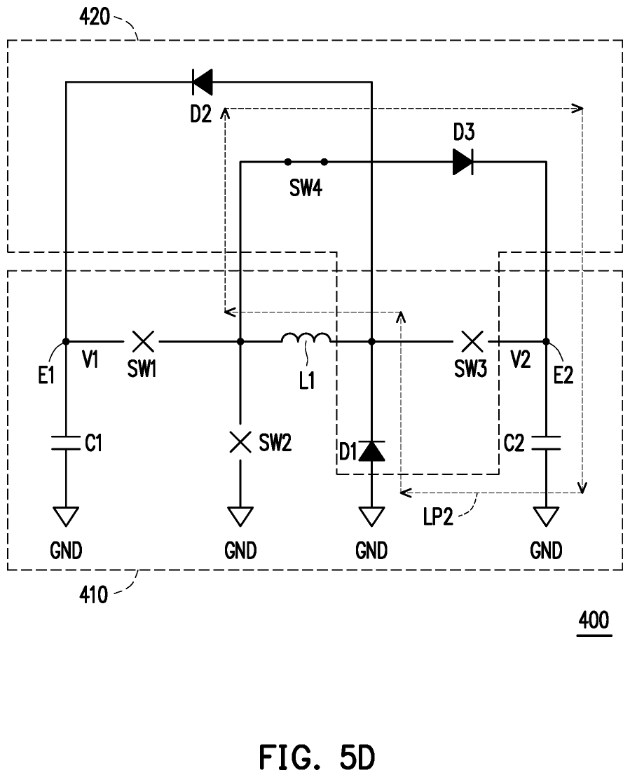

Regarding the operation method of a voltage converter 400, please refer to FIG. 5A to FIG. 5D. FIG. 5A to FIG. 5D respectively illustrate equivalent circuit diagrams of a plurality of operation methods of a voltage converter. In FIG. 5A, the voltage converter 400 operates during the operation time period in the buck mode. During the operation time period, the switches SW1 and SW2 are interactively turned on and turned off, and a voltage V2 is generated on the second power end E2 through the voltage converting operation of buck according to the voltage V1 on the first power end E1.

On the other hand, in the auxiliary circuit 420, the switch SW3 is constantly in a turn-on state, and the switch SW4 is constantly in a turn-off state.

In FIG. 5B, the voltage converter 400 operates during the reset time period in the boost mode. During the reset time period, in the voltage converting circuit 410, the switch SW1 is constantly in the turn-off state, and the switch SW2 is constantly in the turn-on state. The voltage converting operation of the voltage converting circuit 410 is stopped. In addition, in the auxiliary circuit 420, the switch SW3 is constantly in the turn-off state, and the switch SW4 is in the turn-off state. In this status, the loop LP1 is formed through the reference ground end GND, the switch SW2, the inductor L1, and the diode D2, and the first power end E1. As such, the electric energy on the inductor L1 may be recovered to the first power end E1 through the loop LP1.

In FIG. 5C, the voltage converter 400 operates during the operation period in the boost mode. During the operation period, in the voltage converting circuit 410, the switches SW1 and SW2 are interactively turned on and turned off; and a voltage V1 is generated on the first power end E1 through the voltage converting operation of boost according to the voltage V2 on the second power end E2, where the turn-on state or the turn-off state of the switches SW1 and SW2 is complementary.

On the other hand, in the auxiliary circuit 420, the switch SW3 is constantly in the turn-on state, and the switch SW4 is constantly in the turn-off state.

In FIG. 5D, the voltage converter 400 operates during the reset time period in the boost mode. During the reset time period, in the voltage converting circuit 410, the switches SW1 and SW2 are constantly in the turn-off state. At this time, the voltage converting operation of the voltage converting circuit 410 is stopped. In addition, in the auxiliary circuit 420, the switch SW3 is constantly in the turn-off state, and the switch SW4 is constantly in the turn-on state. In this state, the loop LP2 is formed through the reference ground end GND, the diode D1, the inductor L1, the switch SW4, the diode D3, and the second power end E2. As such, the electric energy on the inductor L1 may be recovered to the second power end E2 through the loop LP2.

It should also be mentioned that, in the aforementioned embodiments, the switches SW1-SW4 may be constructed by transistors or any other kind of semiconductor devices or components. The diodes D1-D3 may be constructed by transistors coupled as diode configuration, P-N junction diode, or any other forms that are familiar to people skilled in the art, which is not limited thereto.

The generation methods of the control signals CT1-CT4 may be generated by disposing a control signal (not illustrated). The control signal generator may be constructed by a pulse width modulation (PWM) signal generator according to the conventional voltage converter technical field, which is not limited thereto.

On the other hand, through a simple control mechanism, the voltage converter 400 of this embodiment, may effectively execute energy recovery operation, effectively enhance the stability of the voltages V1 and V2, and maintain system efficiency.

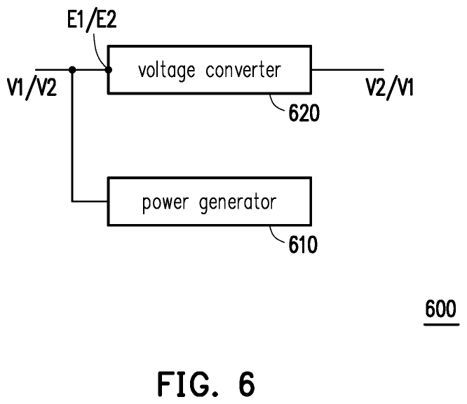

FIG. 6 illustrates a schematic view of a voltage converter of an embodiment of the invention. An alternator apparatus 600 includes a power generator 610 and a voltage converter 620. The voltage converter 620 has a first power end E1 and a second power end E2. The power generator 610 is coupled to the first power end E1 or the second power end E2. The power generator 610 generates a voltage V1 or a voltage V2, and transmits the generated voltage V1 to the first power end E1 or the generated voltage V2 to the second power end E2. When the voltage converter 620 receives the voltage V1 having a relative high voltage value through the first power end E1, the voltage converter 620 executing the voltage converting operation of buck according to the voltage V1, and generates the voltage V2 having a relative low voltage value. In contrast, when the voltage converter 620 receives the voltage V2 having the relative low voltage value through the second power end E2, the voltage converter 620 executes the voltage converting operation of boost according to the voltage V2, and generates the voltage V1 having the relative high voltage value.

The alternator apparatus 600 provides different voltage values of the voltage V1 and V2 so as to generate dual power to drive loads, which require different power consumption in the driving system, so as to enhance power efficiency. Furthermore, the voltage converter 620 may be implemented according to the aforementioned voltage converters 100, 200, 300 or 400, such that when the voltages V1 and V2 occur voltage changes, the output voltage generated by the alternator apparatus 600 is stable. Moreover, through the energy recovery mechanism or the energy flywheel during the reset time period, the power efficiency is improved.

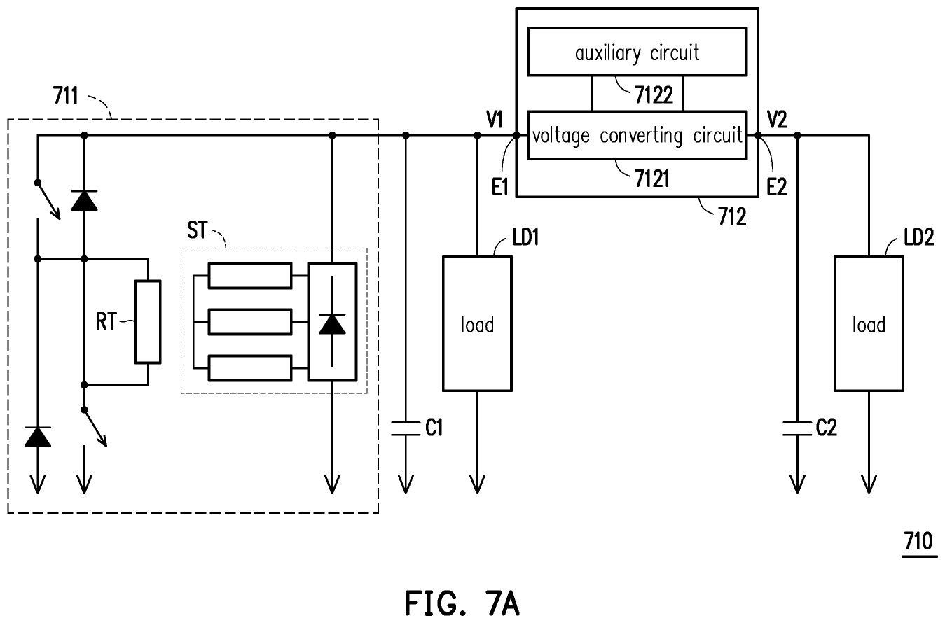

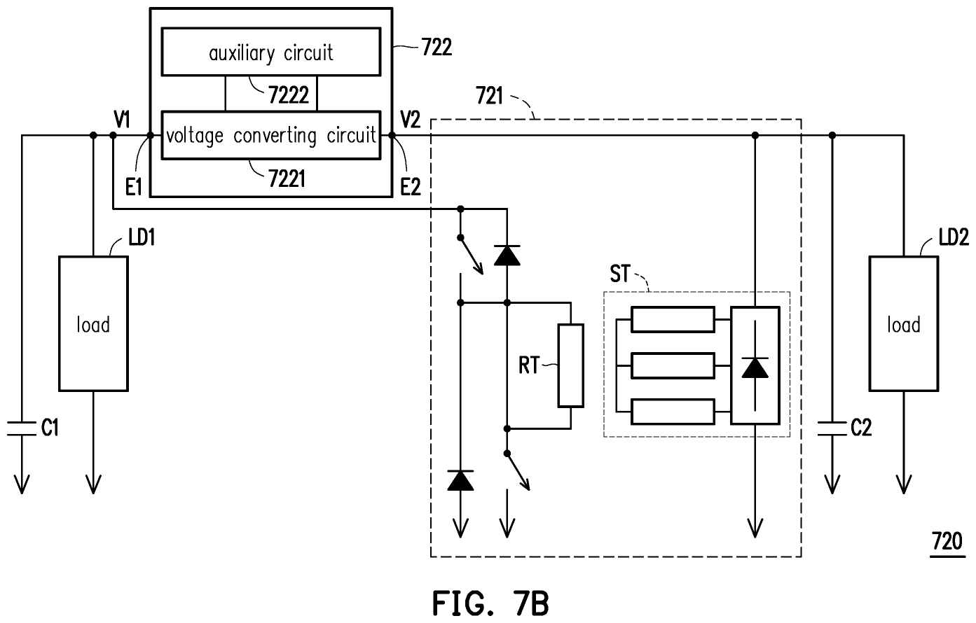

FIG. 7A to FIG. 7B illustrate schematic views of an alternator apparatus of embodiments of the invention. In FIG. 7A, an alternator apparatus 710 includes a power generator 711 and a voltage converter 712. The power generator 711 has a rotor RT and a stator ST. The voltage converter 712 has a voltage converting circuit 7121 and an auxiliary circuit 7122. The power generator 711 is coupled on a first power end E1 of the voltage converter 712, and the voltage V1 is provided to the voltage converter 712 as an input voltage. The voltage converter 712 executes the voltage converting operation of buck according to voltage V1, and generates the voltage V2 on the second power end E1. The voltage V1 and V2 may respectively provide to loads LD1 and LD2 having different power efficiency requirement.

The voltage converter 712 may be implemented according to the aforementioned embodiments of the voltage converters 100, 200, 300 or 400. Regarding operating details of the voltage converter 712, the detailed illustrations are elaborated in the aforementioned embodiments, which shall not be repeated.

In FIG. 7B, an alternator apparatus 720 includes a power generator 721 and a voltage converter 722. The power generator 721 has the rotor RT and the stator ST. The voltage converter 722 has a voltage converting circuit 7221 and an auxiliary circuit 7222. The power generator 721 is coupled on the second power end E2 of the voltage converter 722, and the voltage V2 is provided to the voltage converter 722 as the input voltage. The voltage converter 722 executes the voltage converting operation of boost according to the voltage V2, and the voltage V1 on the first power end E1 is generated. The voltages V1 and V2 may respectively provide to the loads LD1 and LD2 having different efficiency requirement. It should be noted that, in this embodiment, the rotor RT of the power generator 721 receives the voltage V1 having relatively high voltage value to operate excitation to improve the rotor RT excitation efficiency.

The voltage converter 722 may be implemented according to the aforementioned embodiments of the voltage converters 100, 200, 300, or 400. Regarding operating details of the voltage converter 722, the detailed illustrations thereof are elaborated in the aforementioned embodiments, which shall not be repeated.

In summary of the above, the voltage converter having energy recovering ability is disposed in the alternator apparatus of the invention. When the load dumping occurs, the voltage concussion generated by, for example, load instantaneous changes, may be effectively controlled through the energy recovering mechanism of the voltage converter or the energy flywheel mechanism, such that the output voltage generated by the alternator apparatus is stably enhanced, and the system effective operation is maintained.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A voltage converter, comprising:
a voltage converting circuit comprising a first power end, a second power end and an inductor, during an operation time period, converting a first voltage on the first power end to generate a second voltage on the second power end, or converting the second voltage on the second power end to generate the first voltage on the first power end, wherein a voltage value of the first voltage is larger than a voltage value of the second voltage; and
an auxiliary circuit coupled between the first power end and the second power end, during a reset time period, forming a first loop between the first power end and the inductor, or forming a second loop between the second power end and the inductor, or forming a third loop in the auxiliary circuit, wherein the first loop and the second loop are configured to execute an electric energy recovery, and the third loop is configured to execute flywheel energy storage.

2. The voltage converter according to claim 1, wherein the voltage converting circuit further comprises:
a first switch, coupled between the first power end and a first end of the inductor, wherein the first switch is turned on or turned off according to a first control signal; and
a second switch, coupled between the first end of the inductor and a reference ground end, wherein the second switch is turned on or turned off according to a second control signal.

3. The voltage converter according to claim 2, wherein the auxiliary circuit comprises:
a third switch having a first end coupled to the first power end, wherein the third switch is turned on or turned off according to a third control signal;
a fourth switch coupled between a second end of the third switch and the reference ground end, wherein the fourth switch is turned on or turned off according to a fourth control signal; and
an auxiliary inductor having a first end coupled to the second end of the third switch.

4. The voltage converter according to claim 3, wherein an operating bandwidth of the auxiliary circuit is larger than an operating bandwidth of the voltage converting circuit.

5. The voltage converter according to claim 3, wherein during the reset time period in a buck mode, the first switch and the fourth switch are turned off, the second switch and the third switch are turned on, and the first loop is formed through the first power end, the third switch, the auxiliary inductor, the inductor, the second switch and the reference ground end.

6. The voltage converter according to claim 3, wherein during the reset time period in a boost mode, the first switch and the third switch are turned on, the second switch and the fourth switch are turned off, and the third loop is formed through the second power end, the auxiliary inductor, the third switch, the first switch and the inductor.

7. The voltage converter according to claim 3, wherein during the operation time period, the auxiliary circuit converts the second voltage on the second power end to generate a first auxiliary voltage on the first power end, or converts the first voltage on the first power end to generate a second auxiliary voltage on the second power end.

8. The voltage converter according to claim 2, wherein the auxiliary circuit comprises:
a third switch having a first end, a second end and a control end, wherein the first end of the third switch is coupled to a first end of the inductor, and the control end of the third switch receives a third control signal; and
a fourth switch having a first end, a second end and a control end, wherein the first end of the fourth switch is coupled to the second end of the third switch, the second end of the fourth switch is coupled to the second power end, and the control end of the fourth switch receives a fourth control signal,
wherein, during the reset time period, the third switch and the fourth switch are turned on and the third loop is formed.

9. The voltage converter according to claim 8, wherein the third switch and the fourth switch are respectively a first transistor and a second transistor, a first end of the first transistor is coupled to a first end of the inductor, a second end of the first transistor is coupled each other with a bulk end of the first transistor and coupled to a first end of the second transistor, a bulk end of the second transistor is coupled each other with the first end of the second transistor, and a second end of the second transistor is coupled to the second power end.

10. The voltage converter according to claim 2, wherein the voltage converting circuit further comprises:
a third switch coupled between a second end of the inductor and the second power end, and being turned on or turned off according to a third control signal; and
a first diode having an anode and a cathode, wherein the anode of the first diode is coupled to the reference ground end, and the cathode of the first diode is coupled to the second end of the inductor.

11. The voltage converter according to claim 10, wherein the auxiliary circuit comprises:
the third switch;
the first diode;
a second diode having an anode and a cathode, wherein the cathode of the second diode is coupled to the first power end, and the anode of the second diode is coupled to the second end of the inductor;
a fourth switch having a first end coupled to the first end of the inductor, and being turned on or turned off according to a fourth control signal; and
a third diode having an anode and a cathode, wherein the anode of the third diode is coupled to the second end of the fourth switch, and the cathode of the third diode is coupled to the second power end.

12. The voltage converter according to claim 11, wherein during the operation time period in a buck mode, the third switch is turned on, the fourth switch is turned off, the first switch and the second switch are alternately turned on or turned off to execute a voltage converting operation of buck to generate the second voltage according to the first voltage.

13. The voltage converter according to claim 12, wherein during the reset time period in the buck mode, the first switch, the third switch, and the fourth switch are turned off, the second switch is turned on, and the first loop is formed through the reference ground end, the second switch, the inductor, the second diode and the first power end.

14. The voltage converter according to claim 11, wherein during the operation time period in a boost mode, the third switch is turned on, the fourth switch is turned off, the first switch and the second switch are alternately turned on or turned off to execute a voltage converting operation of boost to generate the first voltage according to the second voltage.

15. The voltage converter according to claim 14, wherein during the reset time period in the boost mode, the first switch, the second switch, and the third switch are turned off, the fourth switch is turned on, and the second loop is formed through the reference ground end, the first diode, the inductor, the fourth switch, the third diode and the second power end.

16. An alternator apparatus, comprising:
a power generator, having a rotor and a stator, wherein the stator generates an output voltage; and
the voltage converter according to claim 1,
wherein the power generator transmits the output voltage to the first power end of the voltage converter as a first power, or to the second power end of the voltage converter as a second power.

17. The alternator apparatus according to claim 16, wherein the rotor is coupled to the first power end to receive the first power.
